(19) United States
(12) Patent Application Publication
(10) Pub. No.: US 2007/0121012 A1
(43) Pub. Date: May 31, 2007

(54) Information display method and information display device

(76) Inventors: Yoichi Hida, Ehime (JP); Takami Uemura, Ehime (JP)

Correspondence Address: WENDEROTH, LIND & PONACK L.L.P., 2033 K. STREET, NW, SUITE 800, WASHINGTON, DC, 20006, US

(21) Appl. No.: 10/590,711

(22) PCT Filed: Feb. 25, 2005
(86) PCT No.: PCT/JP05/03188

§ 371 Date: Aug. 25, 2006

(30) Foreign Application Priority Data
Feb. 27, 2004 (JP) 2004-054813

(51) Int. Cl. H04N 9/74; G09G 5/00

(52) U.S. Cl. 348/589; 345/634

(57) ABSTRACT

There is provided an information display method and an information display apparatus which detect a motion of a video signal on a display screen on which OSD is displayed, or on a display position of OSD, and changes the state of the OSD or the display screen when there is a motion, whereby the user can view an image with a motion without missing it.

A state change amount detector (103) obtains the state change amount in the image displayed on the display screen, and an OSD display state changing unit (107) controls the OSD or the display screen when a state change amount judgement unit (104 ) judges that the state change amount is larger than a predetermined value, whereby overlapping between the image with a motion and the OSD can be prevented.

### TECHNICAL FIELD

The present invention relates to an information display method and an information display device for displaying plural pieces of input video information and onscreen display information simultaneously on a display screen, and more particularly, to those which can prevent overlapping of input video information having a motion and onscreen display information in such as a monitoring system.

### BACKGROUND ART

As a conventional method which can prevent overlapping of onscreen display information such as OSD (On Screen Display) and input video information, for example, Patent Document 1 (Japanese Published Patent Application No. Hei. 7-274140 (Page 1, FIG.1)) discloses a method which prevents overlapping of OSD and CC (Closed Caption) when caption display information such as CC included in input video information and onscreen display information are simultaneously displayed on a display screen, as shown in FIG. 15.

FIG. 15 is a conceptual diagram illustrating this kind of OSD control method, which is disclosed in Patent Document 1.

In FIG. 15, reference numeral 1501 denotes a display screen, numeral 1502 denotes a CC display position, and numerals 1503 and 1504 denote OSD display areas.

In this prior art, when the CC display position 1502 and the OSD display position 1503 overlap on the single display screen 1501 as shown in FIG. 15(a), the OSD display position 1503 is moved to a display position 1504 upper than the CC display position 1502 as shown in FIG. 15(b), thereby preventing overlapping of the CC and the OSD.

By the way, information indicating a display position or a display size is included in the caption information such as CC and the onscreen display information such as OSD, and in the above-described prior art structure, information indicating the display position or the display size which is included in the caption information or the onscreen display information is employed to judge as to whether the caption information and the onscreen display information overlap with each other or not. However, in a device having no means for obtaining the caption information, it was impossible to determine to which position on the screen the onscreen display information is to be moved.

To be specific, the above-mentioned prior art structure is effective only in a device having means for obtaining the caption information, such as a TV broadcast tuner, and since a monitor system or the like which has an external input device such as a camera as an input source is not provided with means for obtaining the caption information, it was impossible to determine to which position on the display screen the onscreen display information is to be moved, and it was impossible to move the onscreen display information. Therefore, even when important information is displayed on the display screen that is overlapped with the onscreen information, the user is likely to miss the important information due to the displayed onscreen display information.

The present invention is directed to solving the above-described problems and has for its object to provide an information display method and an information display device which can prevent the user from missing information necessary for him/her, even when input video information having a motion is displayed on a display screen in a screen display device that cannot utilize external caption information.

Measures to Solve the Problems

In order to solve the above-described problems, an information display method according to Claim 1 of the present invention is an information display method for displaying input video information including at least one video on a display screen, and displaying predetermined onscreen display information (hereinafter referred to as OSD) on the display screen, and this method comprises a step of obtaining a display position of the OSD; a step of detecting an amount of state change in the input video information displayed on the display screen; and a step of performing display control for the OSD when the state change amount is larger than a predetermined value.

In the information display method according to Claim 1 of the present invention, since OSD display control is carried out when the state change amount in a display screen corresponding to the OSD display position is large, overlapping display of the OSD and the display screen is resolved by performing display control such as down-sizing the OSD.

According to Claim 2 of the present invention, in the information display method defined in Claim 1, the input video information includes at least two videos; the display screen is divided into plural divisional screens, and displays the input video information including at least two videos; and the step of performing display control for the OSD includes a step of detecting a divisional screen wherein the state change amount is smaller than the predetermined value, and a step of moving the OSD to the divisional screen wherein the state change amount is smaller than the predetermined value.

In the information display method according to Claim 2 of the present invention, since OSD display control is carried out when the state change amount in a divisional screen corresponding to the OSD display position is large, overlapping display of the OSD and the display screen is resolved by performing display control such as moving the OSD.

According to Claim 3 of the present invention, the information display method defined in Claim 1 further including a step of detecting a state change position in the display screen.

In the information display method according to Claim 3 of the present invention, since the position where a state change occurs in the display screen is detected, the OSD display control is facilitated.

According to Claim 4 of the present invention, in the information display method defined in Claim 1, the state change amount is a total sum of change amounts of luminance values obtained for every predetermined period of time, of the input video information that is digitized.

In the information display method according to Claim 4 of the present invention, detection of the state change amount can be carried out by an easy operation.

According to Claim 5 of the present invention, in the information display method defined in Claim 1, the state change amount is an amount of change in audio level obtained for every predetermined period of time, of audio information included in the input video information that is digitized.

In the information display method according to Claim 5 of the present invention, it is possible to detect that there is a motion in the input video information by detecting a change in the audio level.

According to Claim 6 of the present invention, in the information display method defined in Claim 1, the state change amount is detected by a motion detector that performs motion detection for the input video information.

In the information display method according to Claim 6 of the present invention, since the state change amount is detected by a motion detector that performs motion detection for an object, such as a human sensor, the processing of the information display method itself is reduced.

According to Claim 7 of the present invention, in the information display method defined in Claim 2, when the display position of the OSD overlaps with a divisional screen wherein the state change amount in the input video information in each input video information display area of the divisional screen is larger than the predetermined value, the display position of the OSD is moved to a divisional screen wherein the state change amount in the input video information in each input video information display area of the divisional screen is smaller than the predetermined value.

In the information display method according to Claim 7 of the present invention, since the OSD can be moved to a divisional screen having a less amount of state change, overlapping display of the OSD and the divisional display screen is resolved, whereby the viewability of the divisional display screen is improved.

According to Claim 8 of the present invention, in the information display method defined in Claim 2, when the display position of the OSD overlaps with a divisional screen wherein the state change amount in the input video information in each input video information display area of the divisional screen is larger than the predetermined value, the OSD is not displayed.

In the information display method according to Claim 8 of the present invention, since the OSD that overlaps with a divisional screen having a large amount of state change can be hidden, overlapping display of the OSD and the divisional display screen is resolved, whereby the viewability of the divisional display screen is improved.

According to Claim 9 of the present invention, in the information display method defined in Claim 2, when the display position of the OSD overlaps with a divisional screen wherein the state change amount in the input video information in each input video information display area of the divisional screen is larger than the predetermined value, the input video information is displayed at the front of the OSD with the input video information penetrating through the OSD.

In the information display method according to Claim 9 of the present invention, since the OSD that overlaps with a divisional screen having a large amount of state change can be transparently displayed, overlapping display of the OSD and the divisional display screen is resolved, whereby the viewability of the divisional display screen is improved.

According to Claim 10 of the present invention, in the information display method defined in Claim 2, when the display position of the OSD overlaps with a divisional screen wherein the state change amount in the input video information in each input video information display area of the divisional screen is larger than the predetermined value, the OSD is displayed with its size being reduced.

In the information display method according to Claim 10 of the present invention, since the OSD that overlaps with a divisional screen having a large amount of state change can be down-sized, overlapping display of the OSD and the divisional display screen is resolved, whereby the viewability of the divisional display screen is improved.

According to Claim 11 of the present invention, in the information display method defined in Claim 2, when the display position of the OSD overlaps with a divisional screen wherein the state change amount in the input video information in each input video information display area of the divisional screen is larger than the predetermined value, the OSD is displayed in an area other than the input video information display areas on the screen.

In the information display method according to Claim 11 of the present invention, since the OSD that overlaps with a divisional screen having a large amount of state change can be moved, overlapping display of the OSD and the divisional display screen is resolved, whereby the viewability of the divisional display screen is improved.

According to Claim 12 of the present invention, in the information display method defined in Claim 2, when the display position of the OSD overlaps with a divisional screen wherein the state change amount in the input video information in each input video information display area of the divisional screen is larger than the predetermined value, the input video information display area that overlaps with the display state change position is extended to an arbitrary size.

In the information display method according to Claim 12 of the present invention, when the OSD overlaps with a divisional screen having a large amount of state change, since the divisional screen can be extended, a region hidden by the OSD is reduced, whereby the viewability of the divisional display screen is improved.

According to Claim 13 of the present invention, the information display method defined in Claim 1 further including a step of adding priorities to the input video information.

In the information display method according to Claim 13 of the present invention, since priorities are previously assigned, the OSD moving process is facilitated.

According to Claim 14 of the present invention, the information display method defined in Claim 1 further including a step of adding priorities to the respective input video information display areas of the divisional screens.

In the information display method according to Claim 14 of the present invention, since priorities are previously assigned, the OSD moving process is facilitated.

According to Claim 15 of the present invention, in the information display method defined in Claim 14, when the display position of the OSD overlaps with a divisional screen wherein the state change amount in the input video information in each input video information display area of the divisional screen is larger than a predetermined value, the display position of the OSD is moved to an area indicating the input video information of the lowest priority, or to an input video information display area of the lowest priority.

In the information display method according to Claim 15 of the present invention, when the OSD overlaps with a divisional screen having a large amount of state change, since the OSD display position can be moved to the display area having the lowest image priority, the OSD moving process is facilitated, whereby the viewability of the divisional display screen is improved.

According to Claim 16 of the present invention, in the information display method defined in Claim 2, when the display position of the OSD overlaps with a divisional screen wherein the state change amount in the input video information in each input video information display area of the divisional screen is larger than the predetermined value, a portion or the whole of the OSD is moved to an input video information display area wherein the amount of display state change in the input video information in the input video information display area is smaller than the predetermined value.

In the information display method according to Claim 16 of the present invention, when the OSD overlaps with a divisional screen having a large amount of state change, the OSD display position can be moved to a display area wherein the amount of display state change is smaller than the predetermined value, whereby the viewability of the divisional display screen is improved.

According to Claim 17 of the present invention, in the information display method defined in Claim 1, when the display position of the OSD overlaps with the state change position on the display screen, the display-position of the OSD is moved to an area wherein the state change amount in the display screen is smaller than a predetermined value.

In the information display method according to Claim 17 of the present invention, when the OSD display position overlaps with the state change position on the display screen, the OSD can be moved to an area wherein the state change amount in the display screen is smaller than the predetermined value, whereby the viewability of the display screen is improved.

According to Claim 18 of the present invention, in the information display method defined in Claim 1, when the display position of the OSD overlaps with the state change position on the display screen, the OSD is not displayed.

In the information display method according to Claim 18 of the present invention, when the OSD display position overlaps with the state change position in the display screen, the OSD is not displayed, whereby the viewability of the display screen is improved.

According to Claim 19 of the present invention, in the information display method defined in Claim 1, when the display position of the OSD overlaps with the state change position on the display screen, the input video information is displayed at the front of the OSD with the input video information penetrating through the OSD.

In the information display method according to Claim 19 of the present invention, when the OSD display position overlaps with the state change position in the display screen, the input video information can be displayed penetrating through the OSD, whereby the viewability of the display screen is improved.

According to Claim 20 of the present invention, in the information display method defined in Claim 1, when the display position of the OSD overlaps with the state change position on the display screen, the OSD is displayed with its size being reduced.

In the information display method according to Claim 20 of the present invention, when the OSD display position overlaps with the state change position in the display screen, the OSD can be down-sized, whereby the viewability of the display screen is improved.

According to Claim 21 of the present invention, in the information display method defined in Claim 1, when the display position of the OSD overlaps with the state change position on the display screen, the input video information in each input video information display area is moved in a predetermined direction to display the same.

In the information display method according to Claim 21 of the present invention, when the OSD display position overlaps with the state change position in the display screen, overlapping between the OSD display position and the state change position of the input video signal is prevented by moving the input image information in the predetermined direction, whereby the viewability of the display screen is improved.

According to Claim 22 of the present invention, in the information display method defined in Claim 1, when the display position of the OSD overlaps with the state change position on the display screen, the OSD is displayed in an area other than the respective input video information display areas on the screen.

In the information display method according to Claim 22 of the present invention, when the OSD display position overlaps with the state change position in the display screen, the OSD can be displayed in an area other than the respective input video information display areas, whereby the viewability of the display screen is improved.

According to Claim 23 of the present invention, in the information display method defined in Claim 1, when the display position of the OSD overlaps with the state change position on the display screen, a portion or the whole of the OSD can be moved to an input video information display area wherein the amount of display state change in the input video information in the input video information display area is smaller than the predetermined value.

In the information display method according to Claim 23 of the present invention, when the OSD display position overlaps with the state change position in the display screen, a portion or the whole of the OSD can be moved to an input video information display area wherein the amount of display state change in the input video information is smaller than the predetermined value, whereby the viewability of the display screen is improved.

According to Claim 24 of the present invention, in the information display method defined in Claim 1, when the OSD is different from its initial display state, the OSD is returned to the initial display state when a predetermined period of time has passed.

In the information display method according to Claim 24 of the present invention, when the OSD is different from its initial display state, the OSD can be returned to the initial display state when a predetermined period of time has passed, whereby the state of the OSD that is changed to improve the viewability of the display screen can be recovered to the initial display state after the predetermined period of time.

According to Claim 25 of the present invention, in the information display method defined in Claim 2, when the OSD is different from its initial display state, the OSD is returned to the initial display state when the state change amount in a divisional screen that overlaps with the initial OSD display position becomes smaller than a predetermined value.

In the information display method according to Claim 25 of the present invention, when the OSD is different from its initial display state, the OSD can be returned to the initial display state- when the state change amount in a divisional screen that overlaps with the initial OSD display position becomes smaller than a predetermined value, whereby the state of the OSD that is changed to improve the viewability of the display screen can be recovered to the initial display state after a predetermined period of time has passed.

According to Claim 26 of the present invention, in the information display method defined in Claim 1, when the OSD is different from its initial display state, the OSD is returned to the initial display state when the state change amount in a state change position that overlaps with the initial OSD display position becomes smaller than a predetermined value.

In the information display method according to Claim 26 of the present invention, when the OSD is different from its initial display state, the OSD can be returned to the initial display state when the state change amount in a state change position that overlaps with the initial OSD display position becomes smaller than a predetermined value, whereby the state of the OSD that is changed to improve the viewability of the display screen can be recovered to the initial display state after a predetermined period of time has passed.

According to Claim 27 of the present invention, in the information display method defined in Claim 1, when the input video information display area is different from its initial state, the input video information display area is returned to the initial display state when a predetermined period of time has passed.

In the information display method according to Claim 27 of the present invention, when the input video information display area is different from its initial state, the input video information display area can be returned to the initial display state when a predetermined period of time has passed, whereby the state of the OSD that is changed to improve the viewability of the display screen can be recovered to the initial display state after the predetermined period of time.

According to Claim 28 of the present invention, in the information display method defined in Claim 2, when the input video information display area is different from its initial display state, the input video information display area is returned to the initial display state when the state change amount in a divisional screen that overlaps with the initial OSD display position becomes smaller than a predetermined value.

In the information display method according to Claim 28 of the present invention, when the input video information display area is different from its initial display state, the input video information display area can be returned to the initial display state when the state change amount in a divisional screen that overlaps with the initial OSD display position becomes smaller than a predetermined value, whereby the state of the OSD that is changed to improve the viewability of the display screen can be recovered to the initial display state after a predetermined period of time has passed.

According to Claim 29 of the present invention, in the information display method defined in Claim 1, when the input video information display area is different from its initial display state, the input video information display area is returned to the initial display state when the state change amount in a state change position that overlaps with the initial OSD display position becomes smaller than a predetermined value.

In the information display method according to Claim 29 of the present invention, when the input video information display area is different from its initial display state, the input video information display area can be returned to the initial display state when the state change amount in a state change position that overlaps with the initial OSD display position becomes smaller than a predetermined value, whereby the state of the OSD that is changed to improve the viewability of the display screen can be recovered to the initial display state after a predetermined period of time has passed.

According to Claim 30 of the present invention, there is provided an information display device for displaying input video information including at least one video on a display screen, and displaying a predetermined OSD on the display screen, and the device comprises an OSD display position acquisition unit for obtaining a display position of the OSD; a state change amount detector for detecting an amount of state change in the input video information displayed on the display screen; and an OSD display controller for performing display control for the OSD when the state change amount is larger than a predetermined value.

In the information display device according to Claim 30 of the present invention, since OSD display control is carried out when the state change amount in a display screen corresponding to the OSD display position is large, overlapping display of the OSD and the display screen is resolved by such as down-size display of the OSD.

According to Claim 31 of the present invention, in the information display device defined in Claim 30, the input video information includes at least two videos; the display screen is divided into plural divisional screens, and displays the input video information including at least two videos; and the OSD display controller includes a divisional screen detector for detecting a divisional screen wherein the state change amount is smaller than the predetermined value, and an OSD display state changing unit for changing the display state of the OSD so as to move the OSD to the divisional screen wherein the state change amount is smaller than the predetermined value.

In the information display device according to Claim 31 of the present invention, since OSD display control is carried out when the state change amount in a divisional screen corresponding to the OSD display position is large, overlapping display of the OSD and the display screen is resolved by, for example, moving the OSD in this case.

According to Claim 32 of the present invention, the information display device defined in Claim 30 further includes a state change position detector for detecting a state change position in the display screen.

In the information display device according to Claim 32 of the present invention, since the position where the state change occurs in the display screen is detected, the OSD display control is facilitated.

According to Claim 33 of the present invention, in the information display device defined in Claim 29 or 30, the state change amount is detected by a motion detector that detects a motion of an object, outside the information display device.

In the information display device according to Claim 33 of the present invention, since the state change amount is detected by a motion detector such as a human sensor, which performs motion detection for input video information to be displayed.

Effects of the Invention

According to the information display method and information display device of the present invention, onscreen display information on a divisional screen is moved to a divisional screen having no motion, and further, a position having a motion in a display screen is detected, and a display position and a display method of the onscreen display information are controlled to prevent overlapping between the position with a motion and the onscreen display information. Therefore, even when onscreen display information is overlapped with an image having a motion, the user can view the image having a motion without missing it, thereby providing an information display method and an information display device which prevent the user from missing information that is important to the user.

### BRIEF DESCRIPTION OF THE DRAWINGS

FIG. 1 is a block diagram illustrating an information display device according to a first embodiment of the present invention.

FIG. 2(a) is a flowchart of an information display method according to the first embodiment.

FIG. 2(b) is a flowchart illustrating an example of a detailed process in a final step in the flow chart of the information display method according to the first embodiment.

FIG. 3 is a conceptual diagram in a case where OSD is displayed on a display screen according to the information display method of the first embodiment.

FIG. 4 is a conceptual diagram illustrating results of state changes in input signals on the respective divisional screens, according to the information display method of the first embodiment.

FIG. 5 is a conceptual diagram in a case where an OSD display position is controlled according to the information display method of the first embodiment.

FIG. 6 is a conceptual diagram in a case where an OSD display position is controlled according to the information display method of the first embodiment.

FIG. 7 is a conceptual diagram in a case where an OSD display position is controlled according to the information display method of the first embodiment.

FIG. 8 is a conceptual diagram in a case where the OSD display position and the display screen are controlled according to the information display method of the first embodiment.

FIG. 9 is a conceptual diagram in a case where the display screen is controlled according to the information display method of the first embodiment.

FIG. 10 is a flowchart of an information display method according to a second embodiment of the present invention.

FIG. 11 is a conceptual diagram illustrating a state change position acquisition method in the information display method according to the second embodiment.

FIG. 12 is a conceptual diagram in a case where the display screen is controlled according to the information display method of the second embodiment.

FIG. 13 is a block diagram illustrating an information display device according to a third embodiment of the present invention.

FIG. 14 is a flowchart illustrating a process of returning the OSD display state to an initial state according to the third embodiment.

FIG. 15(a) is a conceptual diagram of a conventional OSD control method, illustrating a situation where an input video and OSD display overlap.

FIG. 15(b) is a conceptual diagram of a conventional OSD control method, wherein overlapping between the input video information and the OSD display is resolved.

### DESCRIPTION OF THE REFERENCE NUMERALS

101,1301 . . . A/D converter

102,1302 . . . image synthesizer

103,1303 . . . state change amount detector

104,1304 . . . state change amount judgement unit

105,1305 . . . main controller

106,1306 . . . OSD display position acquisition unit

107,1307 . . . OSD display state changing unit

108,1308 . . . D/A converter

301,401,501,601,701,801,901 . . . display area 1 on divisional screen

302,402,502,602,702,802,902 . . . display area 2 on divisional screen

303,403,503,603,703,803,903 . . . display area 3 on divisional screen

304,404,504,604,704,804,904 . . . display area 4 on divisional screen

305,405,505,605,705,805,905,1101,1201,1501 . . . display screen

306,406,506,606,706,806,906,1103,1203,1503, 1504 . . . OSD display position

807 . . . OSD display area

1102,1202 . . . portion with motion on display screen

1309 . . . OSD display state management unit

1502 . . . CC display position

### BEST MODE TO EXECUTE THE PRESENT INVENTION

Hereinafter, embodiments of information display methods and information display devices according to the present invention will be described in detail with reference to the drawings.

### Embodiment 1

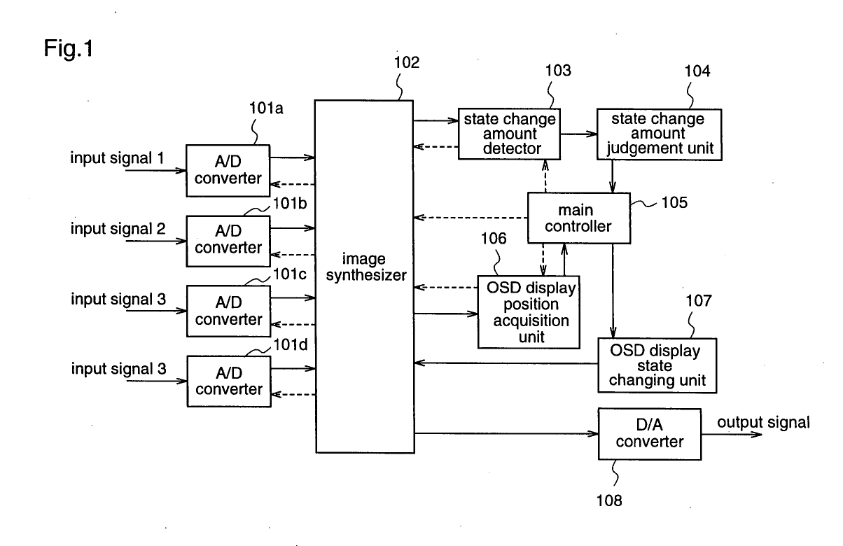

FIG. 1 is a block diagram illustrating an information display device according to a first embodiment of the present invention.

With reference to FIG. 1, 101a˜101d denote A/D converters for analog-to-digital converting input signals 1˜4 that are supplied from a monitor camera or the like (not shown); 102 denotes an image synthesizer for dividing a display area into plural areas to display the plural input signals on a single screen, and overlapping OSD on the display screen; 103 denotes a state change amount detector for detecting the state change amount in each divisional screen; 104 denotes a state change amount judgement unit for judging as to whether the state change amount detected by the state change amount detector 103 is larger or smaller than a predetermined value; 105 denotes a main controller; 106 denotes an OSD display position acquisition unit for obtaining the display position of the OSD on the display screen; 107 denotes an OSD display state changing unit for changing the display state of the OSD so as to move the OSD to a divisional screen where the state change amount is smaller than the predetermined value; and 108 denotes an D/A converter for digital-to-analog converting an output signal to be displayed on the display screen, and outputting the signal to an analog display (not shown). The state change amount judgement unit 104, the main controller 105, and the OSD display state changing unit 107 constitute an OSD display controller for performing OSD display control when the state change amount is larger than the predetermined value. In FIG. 1, solid arrows indicate the flow of data including command processing information, and dashed arrows indicate the flow of the command processing information.

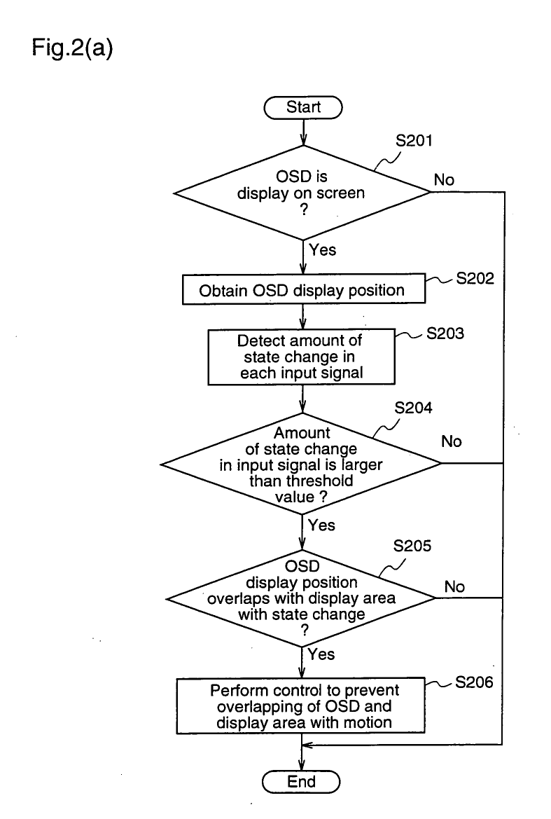

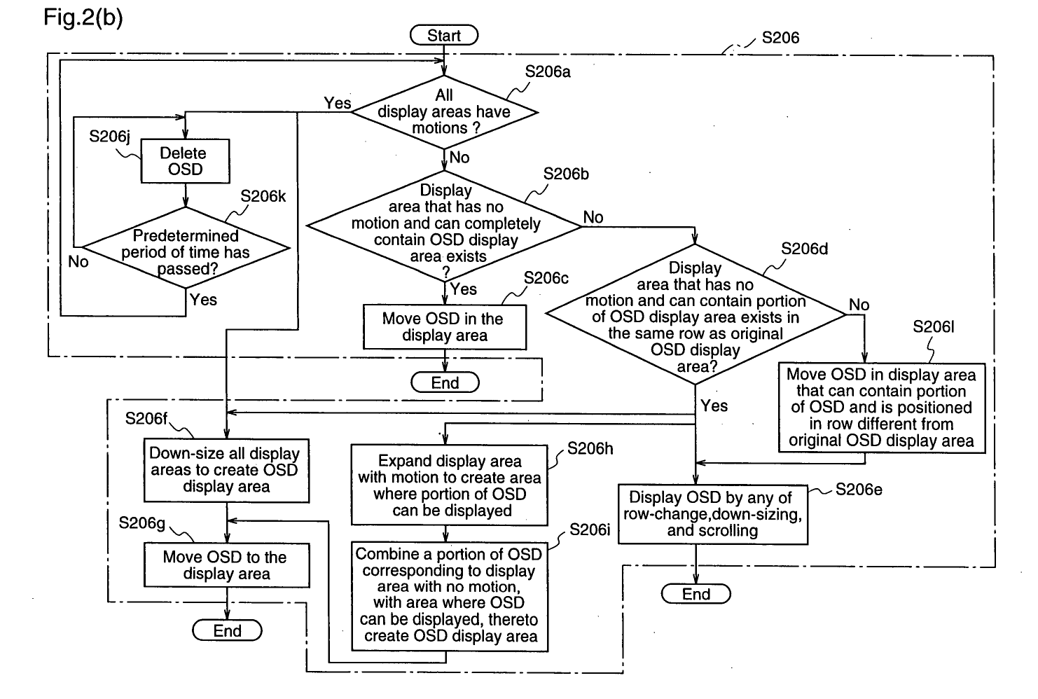

FIGS. 2(a) and 2(b) are flow charts for explaining an information display method according to the first embodiment of the present invention.

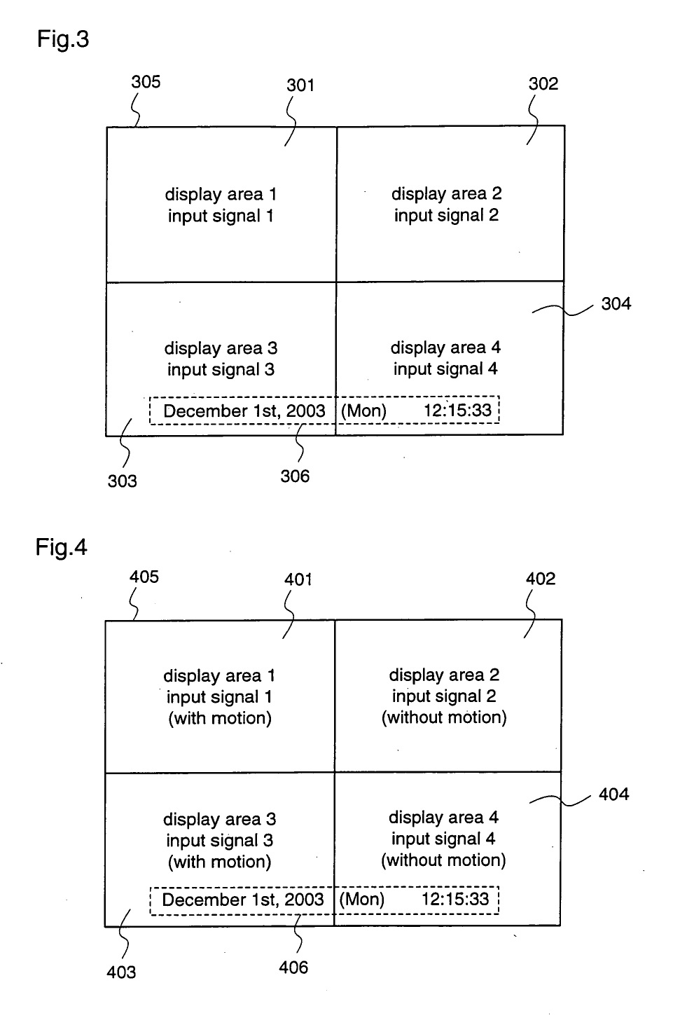

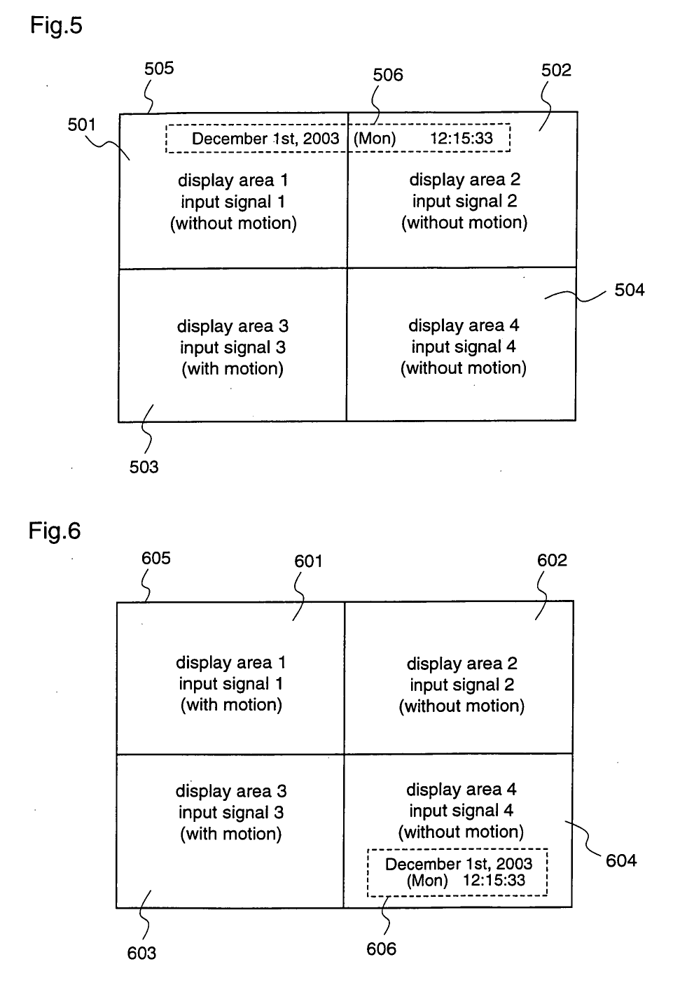

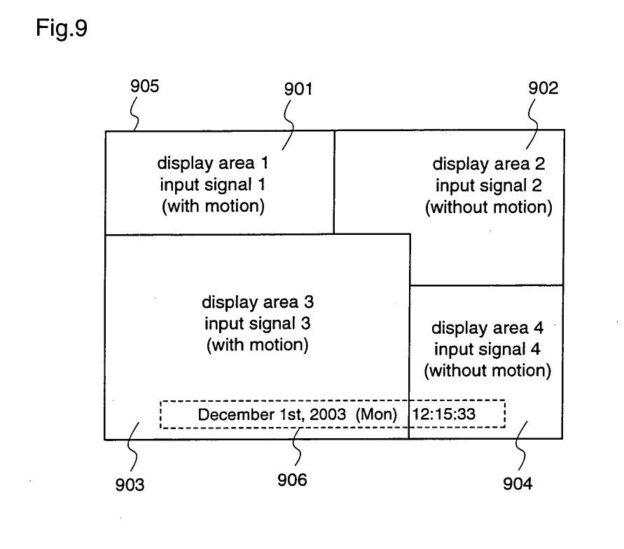

FIG. 3 is a conceptual diagram of the information display method according to the first embodiment, wherein OSD is displayed on the display screen, FIG. 4 is a conceptual diagram illustrating the result of state changes of the input signals to the respective divisional screens, in the information display method according to the first embodiment, FIGS. 5˜7 are conceptual diagrams of the information display method according to the first embodiment, wherein the OSD display position is controlled, FIG. 8 is a conceptual diagram of the information display method according to the first embodiment, wherein the OSD display position and the display screen are controlled, and FIG. 9 is a conceptual diagram of the information display method according to the first embodiment, wherein the display screen is controlled.

In FIGS. 3˜9, 301, 401, 501, 601, 701, 801, and 901 denote display areas 1 on the divisional screens, 302, 402, 502, 602, 702, 802, and 902 denote display areas 2 on the divisional screens, 303, 403, 503, 603, 703, 803, and 903 denote display areas 3 on the divisional screens, 304, 404, 504, 604, 704, 804, and 904 denote display areas 4 on the divisional screens, 305, 405, 505, 605, 705, 805, and 905 denote the display screen, 306, 406, 506, 606, 706, 806, and 906 denote the OSD display positions, and 807 denotes the OSD display area.

Initially, a description will be given of a method for displaying OSD on the divisional screens into which the display screen is divided, in the information display device of the present invention, with reference to FIG. 1.

The plural input signals 1˜4 supplied from an input means such as a camera (not shown) are analog-to-digital converted by the corresponding A/D converters 101a˜101d, and display areas of the respective signals on the display screen are determined by the image synthesizer 102, and then the respective signals are digital-to-analog converted by the D/A converter 108 to be displayed as output signals on the display screen. When the device is instructed by the user to perform display of OSD such as time information or when the device is set to perform OSD display automatically, the main controller 105 outputs an OSD display instruction to the OSD display information changing unit 107, and OSD data is overlapped with the display screen by the image synthesizer 102, and then the synthesis data is transmitted to the D/A converter 108 to be displayed on the display screen.

As for the plural input signals, as shown in FIG. 3, plural images as large as the respective display areas 301˜304 into which the single display screen 305 is divided may be inputted from plural cameras, respectively, or an image as large as the single display screen 305 may be inputted and this image may be reduced to the same size as each display area by a well-known technique such as sampling. Then, these plural input signals are disposed on the corresponding display areas of the single display screen, respectively, and further, these plural input signals are synthesized to obtain a single display screen, and OSD is added to this display screen. This sequence of processes may be performed using a well-known method.

In FIG. 1, the plural input signals are displayed on the signal display screen. However, even in a case where only one signal is inputted, when a display area of the input signal on the display screen is determined by the image synthesizer 102, the entire screen may be determined as a display area for this signal, whereby OSD can be overlapped with the display screen, like in the case where plural input signals are displayed on the respective display areas.

Next, a description will be given of control for preventing overlapping display between OSD and a display area having a motion, when a motion occurs in at least one input signal and OSD is overlapped with a display area that displays the input signal having a motion, with reference to FIGS. 1 and 2(a).

Initially, the main controller 105 determines as to whether OSD is displayed on the display screen or not (refer to S201 in FIG. 2(a)). To be specific, it is judged whether OSD display is manually or automatically made to the main controller 105 or not.

When it is determined that no OSD is displayed on the display screen, control for preventing overlapping display between OSD and a display area having a motion is not carried out. When it is determined that OSD is displayed on the display screen, the OSD display position acquisition unit 106 obtains the OSD display position (refer to S202). This acquisition may be performed by a well-known method, for example, reading of positional information such as coordinates in the OSD display position.

Next, the state change amount detector 103 obtains the amounts of state changes in the respective input signals (refer to S203).

After the state change amount detector 103 obtains the amounts of state changes in the respective display areas, the state change amount judgement unit 104 judges whether the obtained amounts of state changes are larger than a threshold value or not (refer to S204). When it is determined that the amounts of state changes in all the display areas are smaller than the threshold value, control for preventing overlapping display between OSD and a display area having a motion is not carried out. When it is determined that the state change amount in at least one display area is larger than the threshold value, the main controller 105 performs judgement as to whether the OSD display position and the display area having the state change overlap or not (refer to S205).

To be specific, when the result of judgement for the state change amount in step S204 is as shown in FIG. 4, it is determined that the amounts of state changes in the display area 1 (401) and the display area 3 (403) are larger than the threshold value and, therefore, there are motions in the images of the input signals 1 and 3. Since the OSD display position 406 extends across the display area 3 (403) and the display area 4 (404), it is determined in step S205 that the display area 3 (403) in which the state change amount is larger than the threshold value overlaps with the OSD display.

If the state change amount in the display area 3 (403) is smaller than the threshold value, since the OSD display position 406 does not overlap with a display area wherein the state change amount is larger than the threshold value, control for preventing overlapping display between OSD and a display area with motion is not carried out.

As described above, when the state change amount in the display area 3 (403) is larger than the threshold value, since the OSD display overlaps with the display area 3 (403), control is carried out to prevent overlapping of the OSD and the display area 3 (403) having a motion.

Hereinafter, a description will be given of a method for obtaining the amounts of state changes in the input signals, with reference to FIGS. 1 and 3. The amounts of state changes can be easily obtained by executing the following arithmetic operations.

It is assumed that images of the input signals 1˜4 are displayed in the four display areas 1˜4 (301˜304) on the display screen 305. Initially, the state change amount detector 103 detects a total sum M of luminance values of the image of the input signal displayed in the display area 1 (301). Next, the detector 103 detects a total sum N of luminance values of the image of the input signal 1 to be displayed next in the display area 1 (301). Then, an absolute value of a difference between the detected total sums M and N of the luminance values, thereby to obtain the state change amount in the display area 1 (301). Likewise, as for the display areas 2˜4 (302˜304), the amounts of state changes in these display areas 2˜4 (302˜304) can be obtained by obtaining, for each area, an absolute value of a difference between total sums M and N of luminance values.

### DISPLAY CONTROL EXAMPLE 1

Hereinafter, a description will be given of moving of an OSD display position, as an example of control for preventing overlapping of OSD and a display area having a motion, with reference to FIGS. 1 and 5.

When only the state change amount in the display area 3 (503) is larger than the threshold value, the main controller 105 sends a command to the OSD display state changing unit 107 so that the OSD is moved to the display area 1 (501) and the display area 2 (502), and the OSD display state changing unit 107 hides the initially displayed OSD. Then, the image synthesizer 102 overlaps OSD data including a new OSD display position with the display screen, and displays the synthesis data on the display image through the D/A converter 107, whereby the OSD can be moved to the OSD display position 506 on the display areas 1 (501) and 2 (502) having no motion, and the viewability of the display area can be improved.

### DISPLAY CONTROL EXAMPLE 2

Further, a description will be given of a control for preventing overlapping of OSD and a display area having a motion, in a case where one OSD is displayed across plural display areas, with reference to FIGS. 1 and 6. When the amounts of state changes in the display area 1 (601) and the display area 3 (603) are larger than the threshold value, the main controller 105 sends a command to the OSD display state changing unit 107 so that the OSD can be displayed in one display area by line-breaking the OSD, and the OSD display state changing unit 107 hides the initially displayed OSD. Then, the image synthesizer 102 overlaps OSD data including a new OSD display position and a display state such as a line-breaking position, with the display screen, and the synthesis data is displayed on the display screen through the D/A converter 107.

According to this processing, the OSD with the display state being changed can be moved to the OSD display position 606 on the display area 4 (604) having no motion, whereby the OSD display position can be flexibility changed.

### DISPLAY CONTROL EXAMPLE 3

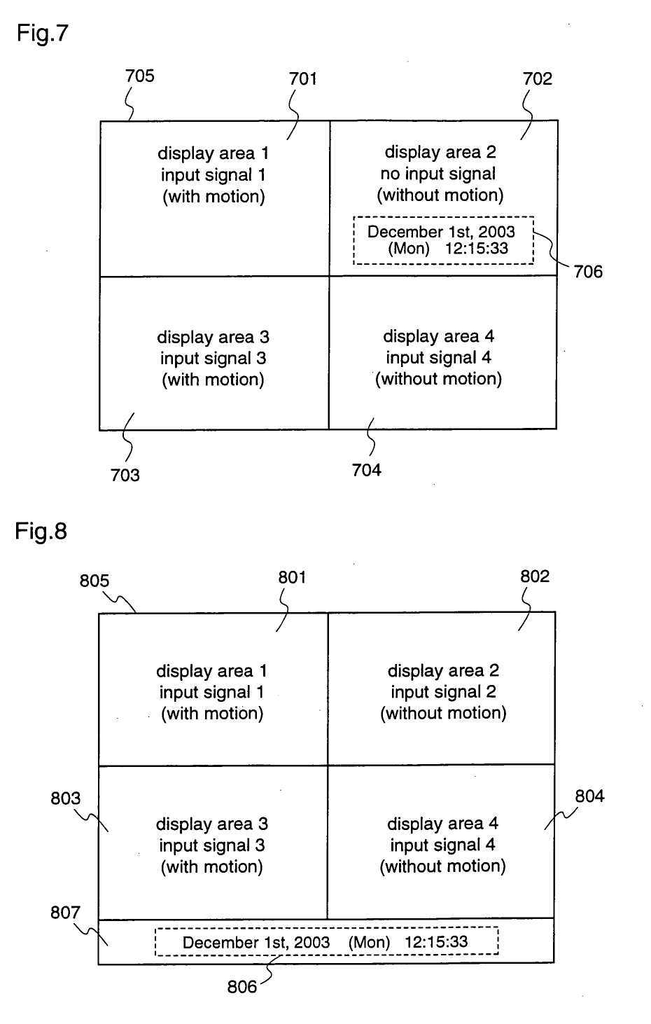

Further, a description will be given of control for preventing overlapping of OSD and a display area having a motion, in a case where no input signal is displayed in a certain display area, with reference to FIGS. 1 and 7. When no image is displayed in the display area 2 (702) due to breaking or the like of the input signal 2, the main controller 105 sends a command to the OSD display state changing unit 107 so that the OSD is preferentially send to the display area 2 (702) wherein no image is displayed, and the OSD display state changing unit 107 hides the initially displayed OSD. Then, the image synthesizer 102 overlaps OSD data including a new OSD display position with the display screen, and displays the synthesis data through the D/A converter 107, whereby the OSD can be moved to the OSD display position 706 on the display area 2 (702) having no motion.

According to this processing, the images in the display areas having input signals can be displayed to the user without being partially hidden by the OSD.

### DISPLAY CONTROL EXAMPLE 4

Further, a description will be given of a control for hiding OSD, as a control for preventing overlapping of OSD and a display area having a motion, with reference to FIG. 1. The main controller 105 sends a command to the OSD display state changing unit 107 so as to hide the OSD, and thereby the OSD display state changing unit 107 hides the initially displayed OSD. Then, the image synthesizer 102 synthesizes only the display screen, and displays the synthesis data on the display screen through the D/A converter 108, whereby the OSD can be hidden.

According to this processing, the image of the display area having a motion can be displayed to the user without being partially hidden by the OSD.

### DISPLAY CONTROL EXAMPLE 5

Further, a description will be given of a control for displaying the image on the display area through the OSD by reducing the luminance value of the OSD, as a control for preventing overlapping of OSD and a display area having a motion, with reference to FIG. 1. The main controller 105 sends a command to the OSD display state changing unit 107 so that the luminance value of the OSD is reduced to display the image on the display screen through the OSD, and the OSD display state changing part 107 hides the initially displayed OSD. Then, the image synthesizer 102 overlaps OSD data including a display state such as the luminance value of the OSD with the display screen, and displays the synthesis data on the display screen through the D/A converter 108, whereby the luminance value of the OSD is reduced to display the image on the display area through the OSD.

According to this processing, the image in the display area having a motion can be displayed to the user without being hidden by the OSD, and further, the information of the OSD can be simultaneously displayed.

### DISPLAY CONTROL EXAMPLE 6

Further, a description will be given of a control for displaying OSD with its display size being reduced, as a control for preventing overlapping of OSD and a display area having a motion, with reference to FIG. 1. The main controller 105 sends a command to the OSD display state changing unit 107 so as to display the OSD with its display size being reduced, and the OSD display state changing unit 107 hides the initially displayed OSD. Then, the image synthesizer 102 overlaps OSD data including a new OSD display position and a display state such as a display size of the OSD, with the display screen, and displays the synthesis data on the display screen through the D/A converter 108, whereby the OSD can be displayed with its display size being reduced.

According to this processing, the image in the display area having a motion can be displayed to the user without being hidden by the OSD, and further, the information of the OSD can be simultaneously displayed.

### DISPLAY CONTROL EXAMPLE 7

Further, a description will be given of a control for previously adding priorities to the display areas or the input signals, as a control for preventing overlapping of OSD and a display area having a motion, with reference to FIG. 2. The main controller 105 previously adds priorities to the display areas or to the input signals, and sends a command to the OSD display state changing unit 107 so as to move the OSD to a display area of the lowest priority or to a display area where an image of an input signal of the lowest priority is displayed. Then, the OSD display state changing unit 107 hides the initially displayed OSD, and the image synthesizer 102 overlaps OSD data including a new OSD display position and a display state such as a line-breaking, with the display screen, and displays the synthesis data on the display screen through the D/A converter 108, whereby the OSD can be moved to the lowest-priority display area or the area where the lowest-priority input signal is displayed.

According to this processing, the OSD transfer process is facilitated, and a display area or an image desired by the user can be displayed to the user without being hidden by the OSD.

### DISPLAY CONTROL EXAMPLE 8

Further, a description will be given of a control for forming a new OSD display area, as a control for preventing overlapping of OSD and a display area having a motion, with reference to FIGS. 1 and 8. The main controller 105 sends a command to the image synthesizer 102 so as to create a new OSD display area 807, and the image synthesizer 102 creates a new OSD display area. Further, the main controller 105 sends a command to the OSD display state changing unit 107 so as to move the OSD display position to the new OSD display area 807, and the OSD display state changing unit 107 hides the initially displayed OSD. Then, the image synthesizer 102 overlaps OSD data including a new OSD display position and a display condition such as line-breaking, with the display screen, and displays the synthesis data on the display screen through the D/A converter 107. Consequently, the OSD can be moved to the new OSD display area 807 that is not overlapped with the display areas 1 (801)˜4(804).

According to this processing, the image in the display area having a motion can be displayed to the user without being hidden by the OSD, and further, the information of the OSD can be simultaneously displayed.

### DISPLAY CONTROL EXAMPLE 9

Further, a description will be given of a control for expanding an image of a display area having a motion to an arbitrary size, as a control for preventing overlapping of OSD and a display area having a motion, with reference to FIGS. 1 and 9. The main controller 105 sends a command to the image synthesizer 102 so as to expand the image of the display area 903 having a motion to an arbitrary size. Then, the image synthesizer 102 expands the denoted display area, overlaps the current OSD data onto the display screen, and displays the synthesis data on the display screen through the D/A converter 107, whereby a portion of the moving image to be hidden by the OSD can be reduced.

According to this processing, it is possible to make the user visually recognize the image having a motion. Further, when there are plural display areas having motions, as described above, priorities may be previously added to the display areas or the input signals, and a display area of the highest priority may be expanded to an arbitrary size.

Although only one of the display control examples 1 to 9 may be previously selected to be executed, the main controller 105 may judge the overlapping status between the display area and the OSD on the basis of the flowchart shown in FIG. 2(b) to arbitrarily select these display control examples. The flowchart shown in FIG. 2(b) shows a specific example of the process of step S206 in FIG. 2(a).

In the flowchart shown in FIG. 2(b), initially, it is judged as to whether all the display areas have motions or not (refer to S206a in FIG. 2(b)).

i) When it is determined that there are no motions, it is judged as to whether there is a display area which has no motion and can contain the OSD display area completely, like the display areas 1 and 2 shown in FIG. 5 (refer to S206b). When such display area exists, the OSD is moved to this display area (refer to S206c).

Further, when it is determined in step S206b that there exists no display area that can completely contain the OSD display area, it is judged whether a display area which has no motion and can contain only a portion of the OSD display area, like the display area 4 shown in FIGS. 6 to 9, exists in the same row as the original display area 3 or 4 (refer to S206d). When it is determined that such display area exists, any of the following steps will be carried out.

ii) As shown in FIG. 6, the OSD is displayed within the display area 4 that is determined as existing, by a well-known method such as line-breaking, down-sizing, or scrolling (refer to S206e).

iii) As shown in FIG. 8, an OSD display area is created by down-sizing the display areas 1˜4 by a well-known method (refer to S206f), and the OSD is moved to the OSD display area (refer to S206g).

iv) As shown in FIG. 9, an area where a portion of the OSD can be displayed is created by expanding the display area 3 having a motion (refer to S206h), and an OSD display area is created by combining the expanded area with an area in the display area 4 having no motion where a portion of the OSD can be displayed (refer to S206i), and the OSD is moved to this area (refer to S206g).

v) Further, when it is determined in step S206d that a display area which has no motion and can contain only a portion of the OSD display area does not exist in the same row as the original display area 3 or 4, the OSD is moved to the display area 2 shown in FIG. 7 which can contain a portion of the OSD and is in the different row from the original OSD display area (refer to S206l), and the OSD is displayed within the display area 2 that is determined as existing, by line-breaking, down-sizing, or scrolling (refer to S206e).

These steps i), ii), iii), iv), and v) correspond to the above-mentioned display control examples 1, 2, 8, 9, and 3, respectively.

When it is determined in step S206a that all the display areas have motions, the OSD is deleted until a predetermined period of time has passed (refer to S206j and S206k). In this case, all the display areas may be down-sized to create an OSD display area as shown in FIG. 8, in steps S206f and S206g.

Further, although it is not shown in this flowchart, controls corresponding to the display control examples 4 to 7 may be carried out.

As described above, according to the first embodiment, it is judged as to whether the amounts of state changes in the videos displayed in the respective display areas are larger than the threshold value or not. When the OSD is overlapped with a display area wherein the state change amount is larger than the threshold value, the OSD is moved to a display area wherein the state change amount is smaller than the threshold value, thereby providing an information display method and an information display device which prevent the user from missing information required by the user, such as an image with a motion.

The state change amount in each input signal according to the first embodiment may be the amount of change in audio level included in the input signal, and the state change judgement unit 104 may judge as to whether a motion occurs or not, by checking whether the amount of change in the audio level is larger than a threshold value or not.

Further, when the state change amount in the input signal according to the first embodiment is obtained by a motion detector such as a well-known human sensor which is disposed outside the information display device, it is possible to realize an information display device that can dispense with the state change amount detector 103 and the state change judgement unit 104, leading to reductions in the circuit scale and cost.

### Embodiment 2

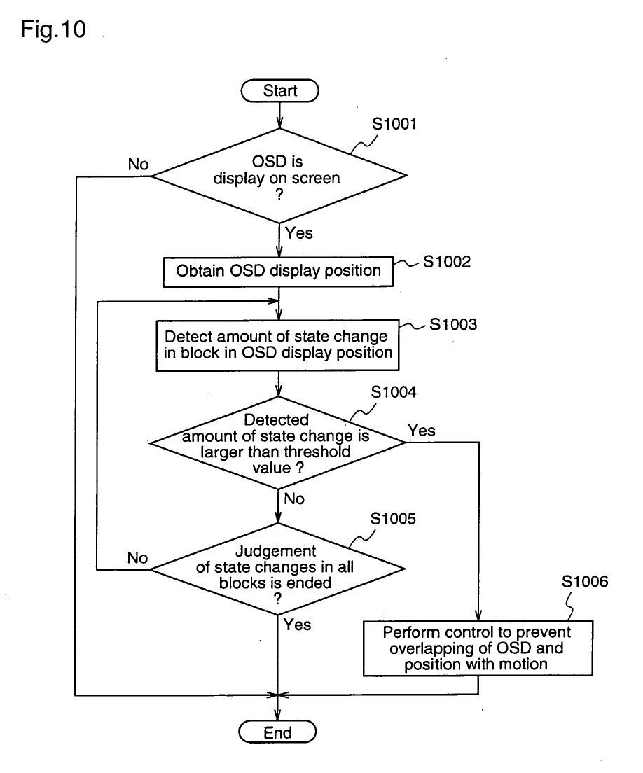

FIG. 10 is a flowchart illustrating an information display method according to a second embodiment of the present invention.

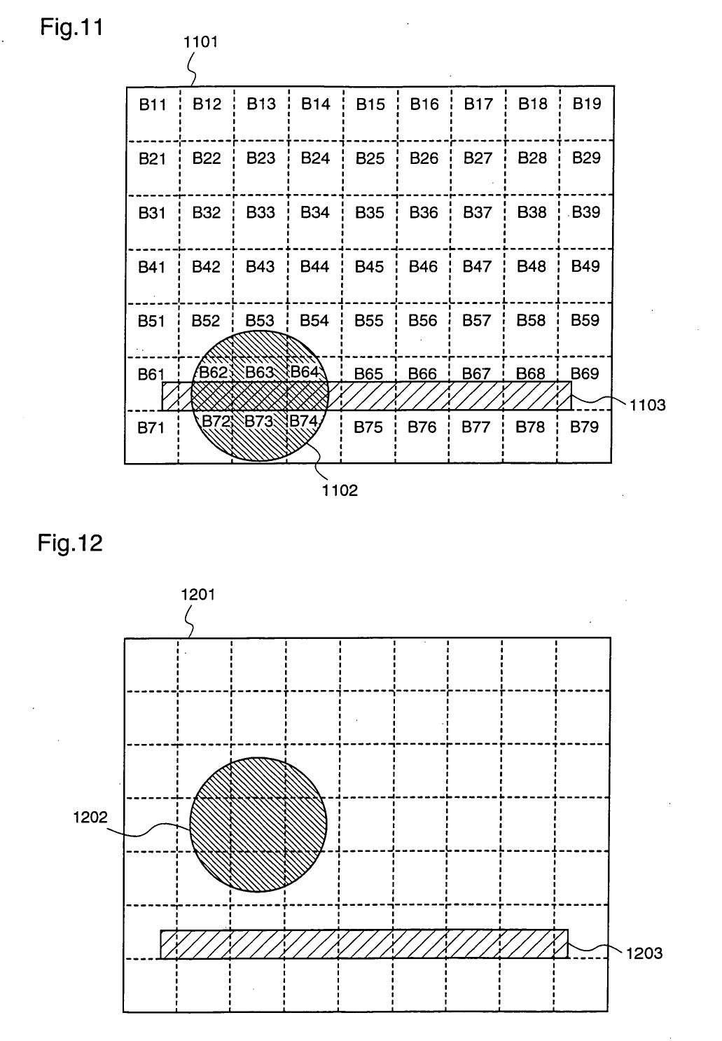

FIG. 11 is a conceptual diagram illustrating a state change position acquisition method in the information display method according to the second embodiment of the present invention.

FIG. 12 is a conceptual diagram illustrating the case where a display screen is controlled by the information display method according to the second embodiment of the present invention.

With reference to FIG. 11, 1101 denotes a display screen, 1102 denotes a portion having a motion on the display screen, and 1103 denotes an OSD display position. In FIG. 11, B11˜B79 are block numbers, i.e., display position data assigned to the respective blocks which are obtained by dividing the display screen into parts of an arbitrary size.

In FIG. 12, 1201 denotes a display screen, 1202 denotes a portion having a motion on the display screen, and 1203 denotes an OSD display position.

A description will be given of an OSD control in the case where a motion occurs in at least one input signal, and OSD overlaps with a position of an input signal having a motion on the display screen, in the information display method and information display device according to the second embodiment, with reference to FIGS. 1 and 10˜12.

Since the processes in steps S1001 and S1002 shown in FIG. 10 are identical to the processes in steps S201 and S202 shown in FIG. 2 according to the first embodiment, repeated description is not necessary. After obtaining an OSD display position in step S1002, the state change amount detector 103 detects the state change amount in the input signal in the OSD display position (refer to S1003 in FIG. 10).

The OSD display area 1103 obtained in step S1002 is an area corresponding to the block numbers B61˜B69 shown in FIG. 11. Initially, the state change amount detector 103 obtains the state change amount in the block number B61 (refer to S1003). A method for obtaining the state change amount in each block is as follows. Initially, an image that is currently displayed on the display screen and an image to be displayed next on the display screen are divided into blocks of the same size, and the state change amount in each block is obtained.

Now, a description will be given of a method for obtaining the state change amount in each block in the OSD display position, with reference to FIGS. 1 and 11. Initially, like the state change amount acquisition method according to the first embodiment, the state change amount detector 103 obtains a total sum m of luminance values in the area of the block number B11 of the image that is currently displayed on the display screen. Next, the state change amount detector 103 obtains a total sum n of luminance values in the area of the block number B11 of the image to be displayed next on the display screen. Then, an absolute value of a difference between the sums m and n of the luminance values, thereby to obtain the state change amount in the area of the block number B11. With respect to the block numbers B12˜B79, the state change amount can be obtained by similar processing. Further, by calculating the state change amount for each block, the state change position on the display screen can easily be obtained. That is, in this second embodiment, the state change amount detector 103 shown in figure 1 also functions as a state change position detector.

Next, it is judged whether the state change amount obtained by the state change amount judgment unit 104 is larger than a threshold value or not (refer to S1004). Since, in FIG. 11, the portion with motion 1102 on the display screen corresponds to the block numbers B52˜B54, B62˜B64, and B72˜B74, and the state change amount in the block number B61 is smaller than the threshold value, the state change amount in the next block number B62 is obtained (refer to S1003). Since the block number B62 corresponds to the portion with motion, the state change amount in the block number B62 is determined as being larger than the threshold value in step S1004, and control for preventing overlapping of the OSD and the position with motion is carried out in step S1006.

The control for preventing overlapping of the OSD and the position with a motion is identical to the control for preventing overlapping of the OSD and the display area with motion according to the first embodiment.

Hereinafter, a description will be given of a control of sliding an image of an input signal in a predetermined direction, as an example of the control for preventing overlapping of the OSD and the position with motion of image which is displayed in the display screen, with reference to FIGS. 1 and 12. The main controller 105 sends a command to the image synthesizer 102 so as to slid the image of the input signal in a predetermined direction to prevent overlapping of the portion with motion 1202 and the OSD display position 1203. The image synthesizer 102 forms an image by sliding the image of the input signal in the predetermined direction, overlaps the current OSD data on the display screen, and displays the image on the display screen through the D/A converter 107, whereby overlapping of the portion with motion 1202 and the OSD display position 1203 can be prevented.

According to this processing, the user can see the OSD information constantly in the same position, and further, the user is prevented from missing information that is necessary for the user, such as an image with a motion.

i) When a divisional screen with a large amount of state change overlaps with OSD, the display position of the OSD may be moved to a display area where the amount of display state change is smaller than a predetermined value, thereby to improve the viewability of the divisional display screen.

ii) When the OSD display position overlaps with the state change position on the display screen, the OSD may be moved to an area where the state change amount of the display screen is smaller than the predetermined value, thereby to improve the viewability of the display screen.

iii) When the OSD display position overlaps with the state change position on the display screen, the OSD may be hidden to improve the viewability of the display screen.

iv) When the OSD display position overlaps with the state change position on the display screen, the input video information may be displayed penetrating through the OSD, thereby to improve the viewability of the display screen.

v) When the OSD display position overlaps with the state change position on the display screen, the OSD may be down-sized to improve the viewability of the display screen.

vi) When the OSD display position overlaps with the state change position on the display screen, the input video information may be moved in a predetermined direction to improve the viewability of the display screen.

vii) When the OSD display position overlaps with the state change position on the display screen, the OSD may be displayed in an area other than the respective input video information display areas to improve the viewability of the display screen.

viii) When the OSD display position overlaps with the state change position on the display screen, a portion or the whole of the OSD may be moved to an input video information display area where the amount of display state change of input video information is smaller than the predetermined value, thereby to improve the viewability of the display screen.

As described above, according to the second embodiment, the display screen is divided into blocks of an arbitrary size, and it is judged as to whether the state change amount in an image displayed in a block where OSD is displayed is larger than a threshold value or not. When the state change amount is larger than the threshold value, the OSD is moved to a display area or a block where the state change amount is smaller than the threshold value, thereby providing an information display method and an information display device which prevent the user from missing information that is necessary for the user, such as an image with a motion.

While in this second embodiment detection of a position wherein an image displayed on the display screen has motion is carried out by comparing the amounts of state changes in the respective blocks, the same effects as mentioned above can be achieved even when the detection is carried out by comparing the amounts of changes in MPEG motion vectors.

### Embodiment 3

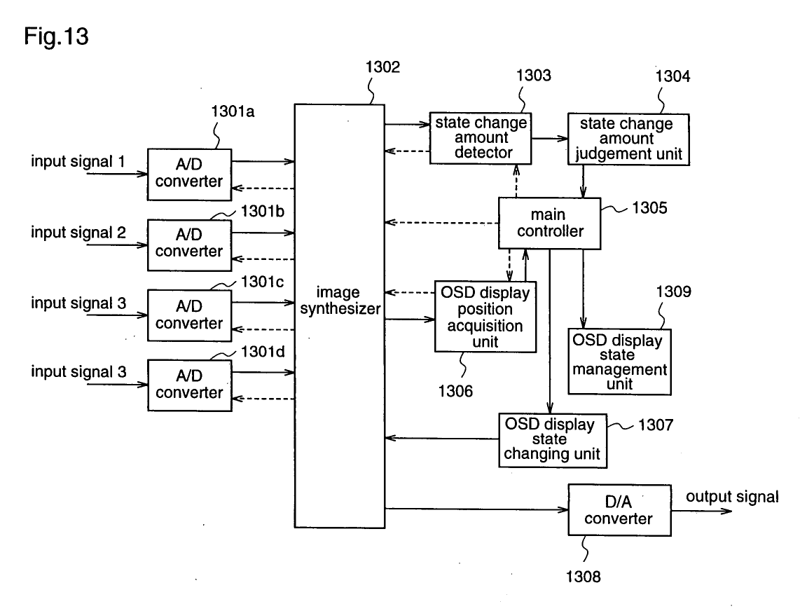

FIG. 13 is a block diagram of an information display device according to a third embodiment of the present invention.

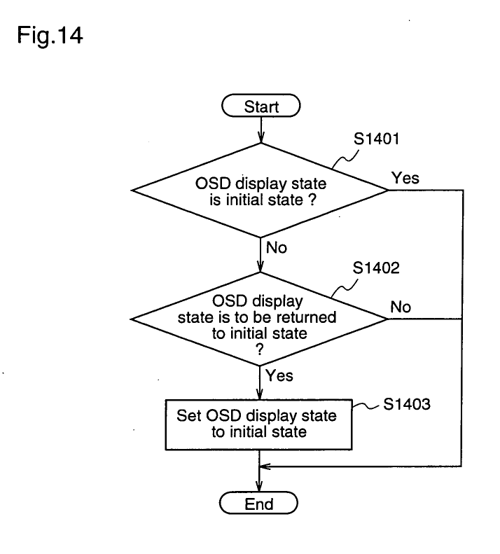

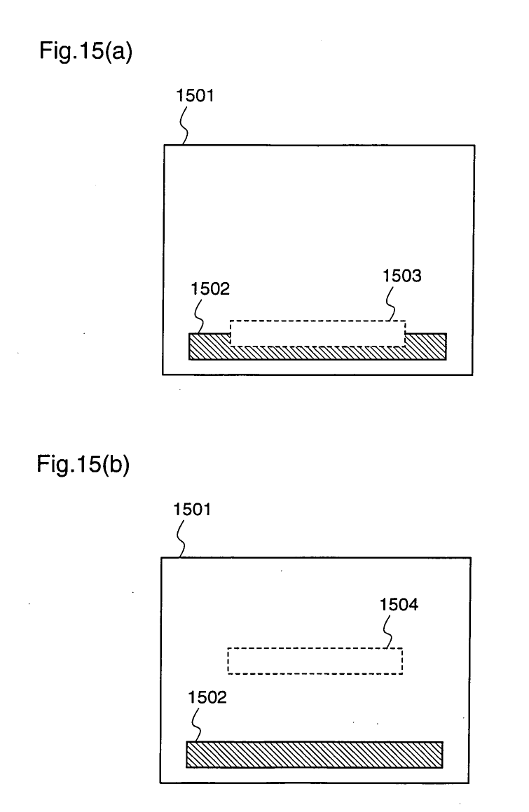

FIG. 14 is a flowchart illustrating a process for returning an OSD display state to an initial state according to the third embodiment of the present invention.

In FIG. 13, 1301˜1308 are identical to 101˜108 shown in FIG. 1 described for the first embodiment, and therefore, repeated description is not necessary. An OSD display state management unit 1309 is a part wherein the display state of OSD or a display screen is stored. As described for the first and second embodiments, when the OSD display state is changed, the main controller 1305 sends a command of OSD display state change to the OSD display state changing unit 1307 and, simultaneously, sends a command to hold the changed OSD display state to the OSD display state management unit 1309. To be specific, when the information display device is started, the OSD display position 306 shown in FIG. 3 is stored in the OSD display state management unit 1309. Next, as described for the first and second embodiments, when the display state of the OSD or the display screen is changed, the changed display state of the OSD or the display screen is stored in the OSD display state management unit 1309.

A description will be given of a process for returning the OSD to its initial display state after changing the display state of the OSD as described for the first or second embodiment, in the information display method and the information display device of the present invention, with reference to FIGS. 13 and 14.

The main controller 1305 judges as to whether the display state of the OSD or the display screen, which is stored in the OSD display state management unit 1309, is the initial state at start-up of the information display device or not (refer to S1401 in FIG. 14). When the display state of the OSD or the display screen which is stored in the OSD display state management unit 1309 is not the initial state at start-up of the information display device, i.e., when there is a motion in the input signal and therefore the display state of the OSD or the display screen is changed as described for the first or second embodiment, the main controller 1305 judges as to whether the display state of the OSD or the display screen should be returned to the initial state at start-up or not (refer to S1402). The judgement as to whether the display state of the OSD or the display screen should be returned to the initial state at start-up of the information display device is carried out by judging whether the state change amount in the initial display areas 303˜304 of the OSD or the initial display position 306 of the OSD is larger than the threshold value or not, as described for the first or second embodiment. When the state change amount in the initial display areas 303˜304 of the OSD or the initial display position 306 of the OSD is larger than the threshold value, since it is assumed that there is a motion in the input signal that is displayed in the initial display areas 303˜304 of the OSD or in the initial display position 306 of the OSD, the display state of the OSD or the display area is left as being changed from the initial state. When the state change amount in the initial display areas 303˜304 of the OSD or in the initial display position 306 of the OSD is smaller than the threshold value, since it is judged that there is no motion in the input signal that is displayed in the initial display areas 303˜304 of the OSD or in the initial display position 306 of the OSD, the main controller 1305 sends a command to the OSD display state changing unit 1307 or the image synthesizer 1302 so as to return the OSD or the display screen to the initial state. The OSD display state changing unit 1307 hides the current OSD, and sends OSD data including the initial OSD display position and the initial OSD display state, to the image synthesizer 1302. Then, the image synthesizer 1302 returns the display screen to the initial state, and superposes the sent OSD data on the display screen and displays the synthesis image on the display screen through the D/A converter 1307 (refer to S1403).

As described above, according to the third embodiment, it is judged whether the state change amount in the initial OSD display screen or the initial OSD display position is larger than the threshold value or not, and the OSD or the display screen is returned to the initial state when the state change amount is smaller than the threshold value, thereby providing an information display method and an information display device by which the user can see the OSD constantly in the same position on the display screen that displays an input signal having no motion.

In this third embodiment, the judgement as to whether the display state of the OSD or the display screen should be returned to the initial state at start-up of the information display device is performed by that the state change amount in the display screen or in the initial display position of the OSD returns to a value smaller than the threshold value. However, the display state of the OSD or the display screen may be returned to the initial state when a predetermined period of time has passed.

According to the above-mentioned processing, it is possible to make the user visually recognize that there is a motion in the initial display position of the OSD or in the display screen different from the initial state, when the OSD or the display screen is different from the initial state.

While in the first to third embodiments a monitor system such as a monitor camera is described as an example, the present invention is applicable to arbitrary models that perform OSD display, such as monitors of a television receiver and a personal computer, and a liquid crystal monitor of a digital camera.

Further, in the first to third embodiments, detection of the state change amount is carried out by using an absolute value of a difference in luminance signals, the amount of change in level of an audio signal, an output signal of a motion detector such as a human sensor which is disposed outside the information display device, an MPEG motion vector, or the like. However, any indicator may be employed so long as it can detect that an image has a motion.

### APPLICABILITY IN INDUSTRY

As described above, according to an information display method and an information display device of the present invention, even in a situation where caption information cannot be utilized when OSD information is overlapped with an image having a motion, the user can view the image having a motion without missing it. Particularly, the method and the device are useful when OSD information is displayed overlapping on a multiscreen display device that can monitor plural input signals, such as a monitor system.

1. An information display method for displaying input video information including at least one video on a display screen, and displaying predetermined onscreen display information (hereinafter referred to as OSD) on the display screen, said method comprising:
a step of obtaining a display position of the OSD;
a step of detecting an amount of state change in the input video information displayed on the display screen; and
a step of performing display control for the OSD when the state change amount is larger than a predetermined value.

2. An information display method as defined in claim 1 wherein
the input video information includes at least two videos, and
the display screen is divided into plural divisional screens, and displays the input video information including at least two videos, and
said step of performing display control for the OSD includes,
a step of detecting a divisional screen wherein the state change amount is smaller than the predetermined value, and
a step of moving the OSD to the divisional screen wherein the state change amount is smaller than the predetermined value.

3. An information display method as defined in claim 1 further including a step of detecting a state change position in the display screen.

4. An information display method as defined in claim 1 wherein the state change amount is a total sum of change amounts of luminance values obtained for every predetermined period of time, of the input video information that is digitized.

5. (canceled)

6. An information display method as defined in claim 1 wherein the state change amount is detected by a motion detector that performs motion detection to the input video information.

7. An information display method as defined in claim 2 wherein
when the display position of the OSD overlaps with a divisional screen wherein the state change amount in the input video information in each input video information display area of the divisional screen is larger than the predetermined value, the display position of the OSD is moved to a divisional screen wherein the state change amount in the input video information in each input video information display area of the divisional screen is smaller than the predetermined value.

8. An information display method as defined in claim 2 wherein
when the display position of the OSD overlaps with a divisional screen wherein the state change amount in the input video information in each input video information display area of the divisional screen is larger than the predetermined value, the OSD is not displayed.

9. An information display method as defined in claim 2 wherein
when the display position of the OSD overlaps with a divisional screen wherein the state change amount in the input video information in each input video information display area of the divisional screen is larger than the predetermined value, the input video information is displayed at the front of the OSD with the input video information penetrating through the OSD.

10. An information display method as defined in claim 2 wherein
when the display position of the OSD overlaps with a divisional screen wherein the state change amount in the input video information in each input video information display area of the divisional screen is larger than the predetermined value, the OSD is displayed with its size being reduced.

11. An information display method as defined in claim 2 wherein
when the display position of the OSD overlaps with a divisional screen wherein the state change amount in the input video information in each input video information display area of the divisional screen is larger than the predetermined value, the OSD is displayed in an area other than the input video information display areas on the screen.

12. An information display method as defined in claim 2 wherein
when the display position of the OSD overlaps with a divisional screen wherein the state change amount in the input video information in each input video information display area of the divisional screen is larger than the predetermined value, the input video information display area that overlaps with the display state change position is extended to an arbitrary size.

13. (canceled)

14. (canceled)

15. (canceled)

16. An information display method as defined in claim 2 wherein
when the display position of the OSD overlaps with a divisional screen wherein the state change amount in the input video information in each input video information display area of the divisional screen is larger than the predetermined value, a portion or the whole of the OSD is moved to an input video information display area wherein the amount of display state change in the input video information in the input video information display area is smaller than the predetermined value.

17. An information display method as defined in claim 1 wherein
when the display position of the OSD overlaps with the state change position on the display screen, the display position of the OSD is moved to an area wherein the state change amount in the display screen is smaller than a predetermined value.

18. An information display method as defined in claim 1 wherein
when the display position of the OSD overlaps with the state change position on the display screen, the OSD is not displayed.

19. An information display method as defined in claim 1 wherein
when the display position of the OSD overlaps with the state change position on the display screen, the input video information is displayed at the front of the OSD with the input video information penetrating through the OSD.

20. An information display method as defined in claim 1 wherein
when the display position of the OSD overlaps with the state change position on the display screen, the OSD is displayed with its size being reduced.

21. (canceled)

22. (canceled)

23. An information display method as defined in claim 1 wherein
when the display position of the OSD overlaps with the state change position on the display screen, a portion or the whole of the OSD is moved to an input video information display area wherein the amount of display state change in the input video information in the input video information display area is smaller than the predetermined value.

24. An information display method as defined in claim 1 wherein
when the OSD is different from its initial display state, the OSD is returned to the initial display state when a predetermined period of time has passed.

25. An information display method as defined in claim 2 wherein
when the OSD is different from its initial display state, the OSD is returned to the initial display state when the state change amount in a divisional screen that overlaps with the initial OSD display position becomes smaller than a predetermined value.

26. An information display method as defined in claim 1 wherein
when the OSD is different from its initial display state, the OSD is returned to the initial display state when the state change amount in a state change position that overlaps with the initial OSD display position becomes smaller than a predetermined value.

27. An information display method as defined in claim 1 wherein
when the input video information display area is different from its initial state, the input video information display area is returned to the initial display state when a predetermined period of time has passed.

28. An information display method as defined in claim 2 wherein
when the input video information display area is different from its initial display state, the input video information display area is returned to the initial display state when the state change amount in a divisional screen that overlaps with the initial OSD display position becomes smaller than a predetermined value.

29. An information display method as defined in claim 1 wherein
when the input video information display area is different from its initial display state, the input video information display area is returned to the initial display state when the state change amount in a state change position that overlaps with the initial OSD display position becomes smaller than a predetermined value.

30. An information display device for displaying input video information including at least one video on a display screen, and displaying a predetermined OSD on the display screen, said device comprising:
an OSD display position acquisition unit for obtaining a display position of the OSD;
a state change amount detector for detecting an amount of state change in the input video information displayed on the display screen; and
an OSD display controller for performing display control for the OSD when the state change amount is larger than a predetermined value.

31. An information display device as defined in claim 30 wherein
the input video information includes at least two videos, and
the display screen is divided into plural divisional screens, and displays the input video information including at least two videos, and
said OSD display controller includes,
a divisional screen detector for detecting a divisional screen wherein the state change amount is smaller than the predetermined value, and
an OSD display state changing unit for changing the display state of the OSD so as to move the OSD to the divisional screen wherein the state change amount is smaller than the predetermined value.

32. An information display device, as defined in claim 30 further including a state change position detector for detecting a state change position in the display screen.

33. An information display device as defined in claim 30 wherein the state change amount is detected by a motion detector that detects a motion of an object, outside the information display device.
